(19) United States
(12) Patent Application Publication
(10) Pub. No.: US 2024/0202499 A1
(43) Pub. Date: Jun. 20, 2024

(54) ELEMENT TEXT PROCESSING METHOD AND APPARATUS, ELECTRONIC DEVICE, AND STORAGE MEDIUM

(71) Applicant: JINGDONG TECHNOLOGY HOLDING CO., LTD., Beijing (CN)

(72) Inventors: Jiahui LIANG, Beijing (CN); Junwei BAO, Beijing (CN)

(21) Appl. No.: 18/286,906

(22) PCT Filed: Apr. 13, 2022
(86) PCT No.: PCT/CN2022/086637

§ 371 Date: Oct. 13, 2023

(30) Foreign Application Priority Data
Apr. 29, 2021 (CN) 202110476637.8

(51) Int. Cl. G06N 3/0455; G06F 40/166; G06F 40/289

(52) U.S. Cl. CPC G06N 3/0455; G06F 40/166; G06F 40/289

(57) ABSTRACT

A method for processing an element text, includes: acquiring a plurality of pieces of description information and a sample abstract labeled with an element type, of a sample object; extracting an element embedding feature of the element type and a description embedding feature of each of the plurality of pieces of description information; training the joint abstract model using the element embedding feature and the description embedding feature as inputs of a joint abstract model to be trained and using the sample abstract as an output of the joint abstract model, to process commodity description information of a target object to generate a commodity abstract matching a target element type.

### CROSS-REFERENCE TO RELATED APPLICATION

This application is the national phase of International Application No. PCT/CN2022/086637 filed on Apr. 13, 2022, which is based upon and claims priority to Chinese Patent Application No. 202110476637.8 filed on Apr. 29, 2021, the entire content of which is incorporated herein by reference.

### TECHNICAL FIELD

The disclosure relates to the field of deep learning and natural language processing (NLP) technologies in the field of artificial intelligence (AI) technologies, and particularly to, a method for processing an element text, an electronic device and a storage medium.

### BACKGROUND

A text abstraction technology may summarize one or more given documents, to generate a concise text abstract as much as possible while ensuring that important content of original document(s) may be reflected. It is an important research topic in the field of information retrieval and natural language processing (NLP).

### SUMMARY

According to a first aspect of the disclosure, a method for processing an element text is provided and includes:
acquiring a plurality of pieces of description information and a sample abstract labeled with an element type, of a sample object;
extracting an element embedding feature of the element type and a description embedding feature of each of the plurality of pieces of description information; and
using the element embedding feature and the description embedding feature as inputs of a joint abstract model to be trained, and using the sample abstract as an output of the joint abstract model, in which the joint abstract model includes a first model and a second model, and a degree of correlation between each of the plurality of pieces of description information and the element type, output from the first model, is used as an input of the second model, and training the joint abstract model based on a classification loss value of the first model and a decoding loss value of the second model, to process commodity description information of a target object to generate a commodity abstract matching a target element type.

According to a second aspect of the disclosure, an electronic device is provided and includes:
a processor; and,
a memory communicatively connected to the processor; in which,

The memory for storing instructions executable by the processor, and the processor is configured to perform the method for processing an element text as described in the first aspect of the disclosure.

According to a third aspect of the disclosure, a non-transitory computer-readable storage medium with computer instructions stored thereon is provided, in which the computer instructions are configured to cause a computer to perform the method for processing an element text as described in the first aspect of the disclosure.

It should be understood that, the content described in the part is not intended to recognize key or important features of embodiments of the disclosure, nor intended to limit a scope of the disclosure. Other features of the disclosure will be easy to be understood through the following specifications.

### BRIEF DESCRIPTION OF THE DRAWINGS

The drawings are intended to better understand the solutions and do not constitute a limitation to the disclosure.

FIG. 1 is a flowchart illustrating a method for processing an element text according to one or more embodiments of the disclosure;

FIG. 2 is a flowchart illustrating a method for processing an element text according to one or more embodiments of the disclosure;

FIG. 3 is a flowchart illustrating a method for processing an element text according to one or more embodiments of the disclosure;

FIG. 4 is a diagram illustrating comparison of word overlap rates according to one or more embodiments of the disclosure;

FIG. 5 is a diagram illustrating a structure of a joint abstract model according to one or more embodiments of the disclosure;

FIG. 6 is a flowchart illustrating a method for processing an element text according to one or more embodiments of the disclosure;

FIG. 7 is a block diagram illustrating an apparatus for processing an element text according to one or more embodiments of the disclosure;

FIG. 8 is a block diagram illustrating an apparatus for processing an element text according to one or more embodiments of the disclosure;

FIG. 9 is a block diagram illustrating an apparatus for processing an element text according to one or more embodiments of the disclosure;

FIG. 10 is a block diagram illustrating an apparatus for processing an element text according to one or more embodiments of the disclosure; and

FIG. 11 is a block diagram illustrating an electronic device configured to implement the method for processing an element text in one or more embodiments of the disclosure.

### DETAILED DESCRIPTION

The embodiments of the disclosure are described as below with reference to the accompanying drawings, which include various details of the embodiments of the disclosure to facilitate understanding and should be considered as merely exemplary. Therefore, those skilled in the art should realize that various changes and modifications may be made to the embodiments described herein without departing from the scope and spirit of the disclosure. Similarly, for clarity and conciseness, descriptions of well-known functions and structures are omitted in the following descriptions.

FIG. 1 is a flowchart illustrating a method for processing an element text according to embodiments of the disclosure.

As illustrated in FIG. 1, the method for processing an element text may include steps 101 to 103.

At step 101, a plurality of pieces of description information and a sample abstract labeled with an element type, of a sample object, are acquired.

In some embodiments of the disclosure, when a joint abstract model is trained, the plurality of pieces of description information and the sample abstract labeled with the element type, of the sample object, need to be acquired. The sample object may be selected according to different application scenarios, which is not limited herein. For example, the sample object may be a commodity or a news event.

Generally, one sample object may correspond to at least one piece of description information and each piece of description information may include one or more sentences. The description information may describe the sample object from the perspective of different element types. Therefore, there may be different degrees of correlation between one piece of description information and different element types. It may be understood that a language style of the description information is often descriptive rather than generalized.

The method for acquiring the description information may be selected according to a specific application scenario, including but not limited to the following two types.

In a first method, information related to the sample object is crawled from a webpage by using a crawler technology, as the description information.

In a second method, information related to the sample object is artificially extracted, as the description information.

Different from the description information, the sample abstract corresponding to the sample object is often generalized and it may be understood that one sample object may correspond to a plurality of element types and different element types may correspond to different sample abstracts. For example, when the sample object is a mobile phone A and the element type is appearance, the corresponding sample abstract may be: an integrated metal body, with a delicate touch feeling and a comfortable hold feeling; and when the sample object is a mobile phone A and the element type is performance, the corresponding sample abstract may be: chip a adopted, with a smooth operation and a more powerful performance.

The method for labeling the sample abstract with the element type may be selected according to a specific application scenario, including but not limited to the following two types.

In a first method, the sample abstract is manually labeled as the corresponding element type.

In a second method, a plurality of sample abstracts are clustered and sets of sample abstracts belonging to different element types are labeled. It may be understood that, a plurality of sets of sample abstracts may be obtained after clustering processing, and sample abstracts in each set of sample abstracts may be understood as belonging to the same element type, and the sample abstracts in the same set may be labeled as the same element type. The clustering processing method used includes, but is not limited to any one of a K-means method and a density-based clustering method.

At step 102, an element embedding feature of the element type and a description embedding feature of each of the plurality of pieces of description information are extracted.

It may be understood that the current element type and description information are text information, and in some embodiments of the disclosure, a feature extraction needs to be performed on the text information. That is, the element embedding feature of the element type and the description embedding feature corresponding to each of the plurality of pieces of description information are extracted. The method for extracting the above two embedding features may be same or different.

Generally, there may be a plurality of methods for extracting an embedding feature, and it may be selected according to specific application scenarios, including but not limited to: any one of bags of words and term frequency-inverse document frequency (TF-IDF).

At step 103, the element embedding feature and the description embedding feature are used as inputs of a joint abstract model to be trained, and the sample abstract is used as an output of the joint abstract model, in which the joint abstract model includes a first model and a second model, and a degree of correlation between each of the plurality of pieces of description information and the element type, output from the first model, is used as an input of the second model, and the joint abstract model is trained based on a classification loss value of the first model and a decoding loss value of the second model, to process commodity description information of a target object to generate a commodity abstract matching a target element type.

It may be understood that, the trained joint abstract model may output a sample abstract based on an input element embedding feature and an input description embedding feature. An element type corresponding to the input element embedding may be referred to as a target element type; the object may be referred to as a target object; and the output sample abstract may be referred to as a commodity abstract.

The joint abstract model may include the first model and the second model. In some embodiments of the disclosure, the first model may be a deep learning model and may include at least one or at least one kind of neural network model. Deep learning models with different structures may be selected as the first model according to different application scenarios, which are not limited in the disclosure, for example, a recurrent neural network (RNN) model and a convolutional neural network (CNN) model. There are a plurality of methods for training the first model. For example, the description embedding feature and the element embedding feature may be used as inputs, the degree of correlation between description information corresponding to the description embedding feature and the element type corresponding to element embedding feature is used as an output, and the corresponding classification loss function is set to train the first model. The classification loss function includes, but is not limited to, any one of a negative logarithm likelihood loss function and a binary classification cross entropy loss function. The trained first model may output a degree of correlation between each description information and the element type.

The second model may be a deep learning model and may include at least one or at least one kind of neural network model. Deep learning models with different structures may be selected as the second model according to different application scenarios, which are not limited in the disclosure, for example, a sequence-to-sequence model and a convolutional neural network (CNN) model. The input of the second model includes: the degree of correlation between each description information and the element type, output from the first model. The input of the second model may also include an embedding generated by an element embedding and a description embedding. There are a plurality of methods for training the second model. For example, the embedding generated by the element embedding and the description embedding may be used as the input, the text abstract matching the target element type is used as the output, and the corresponding decoding loss function is set to train the second model. The decoding loss function includes, but is not limited to, any one of a mean square error loss function and an average absolute error loss function. The trained second model may output the text abstract matching the target element type.

As described above, the joint abstract model includes the first model and the second model. Therefore, the input, the output and the training process of the first model and the second model are the input, the output and the training process of the joint abstract model. It may be understood that the element embedding feature and the description embedding feature may be used as inputs of the joint abstract model to be trained, the sample abstract may be used as the output of the joint abstract model, and the joint abstract model may be trained based on the classification loss value corresponding to the classification loss function of the first model and the decoding loss value corresponding to the decoding loss function of the second model.

According to the method for processing an element text in embodiments of the disclosure, the element type and the element embedding feature corresponding to the element type are acquired, and the description information and the description embedding feature corresponding to the description information are acquired. The above two embedding features are used as inputs of the joint abstract model, and the sample abstract is used as the output of the joint abstract model to train the joint abstract model. The trained joint abstract model may generate the text abstract by processing the description information.

The method is highly controllable. Different levels of target element types may be set based on different application scenarios, and different text abstracts are generated by controlling the model based on different target element types, and the generated text abstract matches the target element type. Moreover, since the method is based on a generative abstract technology and is not based on an extraction abstract technology, the generated text abstract is readable and conforms to a language habit of human beings.

In embodiments of the disclosure, in order to acquire a more accurate embedding feature, a vocabulary mapping table and an embedding matrix may be used. In some embodiments, step 102 may include steps 201 to 202.

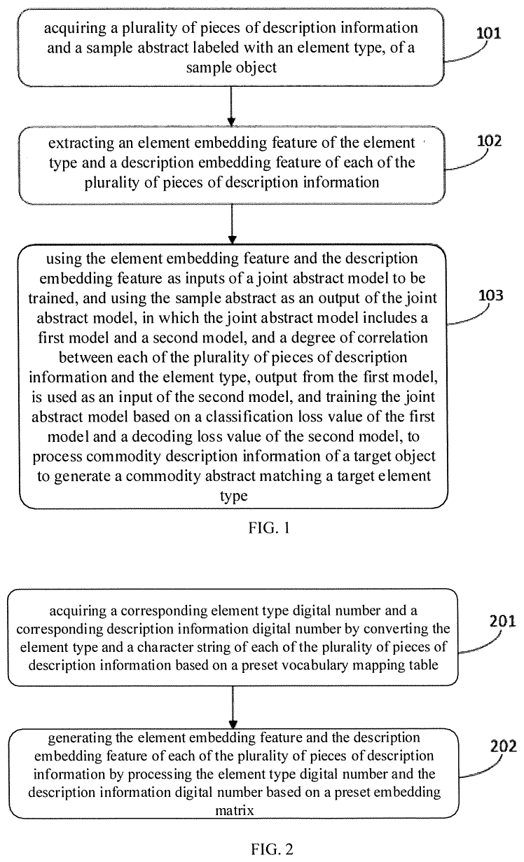

FIG. 2 is a flowchart illustrating a method for processing an element text according to embodiments of the disclosure.

At step 201, a corresponding element type digital number and a corresponding description information digital number are acquired by converting the element type and a character string of each of the plurality of pieces of description information based on a preset vocabulary mapping table.

In some embodiments of the disclosure, there may be the vocabulary mapping table. The vocabulary mapping table may convert words to a corresponding digital number.

Generally, one piece of description information includes a character string. A word segmentation processing may be performed on the description information to obtain a plurality of words corresponding to each of the plurality of pieces of description information. Each word in each of the plurality of pieces of description information may be converted to the corresponding description information digital number based on the vocabulary mapping table; similarly, the element type may be converted to the corresponding element type digital number based on the vocabulary mapping table.

At step 202, the element embedding feature and the description embedding feature of each of the plurality of pieces of description information are generated by processing the element type digital number and the description information digital number based on a preset embedding matrix.

In some embodiments of the disclosure, the embedding matrix may be preset, and corresponding elements may be selected from the embedding matrix based on the element type digital number and the description information digital number, to generate the corresponding embedding feature. It may be understood that, the embedding feature generated based on the element type digital number is the element embedding feature; and the embedding feature generated based on the description information digital number is the description embedding feature.

It may be understood that, there may also be a plurality of preset matrices, and an element embedding matrix and a description embedding matrix may be preset. Corresponding elements may be selected from the element embedding matrix according to the element type digital number, to generate the corresponding element embedding feature; and corresponding elements may be selected from the description embedding matrix according to the description information digital number, to generate the corresponding description embedding feature.

According to the method for processing an element text in embodiments of the disclosure, the more accurate and credible feature embedding is obtained by using the vocabulary mapping table and the embedding matrix, so that calculation of the degree of correlation between the description information and the element type is more accurate. The finally generated text abstract is more closely related to the target element type and the controllability is stronger.

In embodiments of the disclosure, in order to make the degree of correlation between the description information and the element type more accurate, a recurrent neural network (RNN) word-level encoder, an RNN sentence-level encoder and a classifier are designed in the first model; in order to make the text abstract more accurate, an RNN encoder and an RNN decoder are designed in the second model. In some embodiments, a data processing flow of the first model is steps 301 to 303 and a data processing flow of the second model is step 304.

FIG. 3 is a flowchart illustrating a method for processing an element text according to embodiments of the disclosure.

At step 301, word-coding implicit vectors are acquired and averaged as a vector representation of each of the plurality of pieces of description information by inputting the description embedding feature of each of the plurality of pieces of description information into the RNN word-level encoder for encoding processing.

It may be understood that one piece of description information may correspond to a plurality of words after word segmentation processing. Each word may have a corresponding description embedding feature. In some embodiments of the disclosure, the description embedding feature of each of the plurality of pieces of description information may be input into the RNN word-level encoder. A structure of the RNN word-level encoder may be designed according to a same application scenario, which is not limited in the embodiments. For example, the RNN word-level encoder may be a unit including one or more recurrent neurons.

Implicit vectors corresponding to the description embedding feature may be obtained after the RNN word-level encoder. The implicit vectors are implicit vectors obtained after processing the words corresponding to the description information. The vector representation corresponding to the current description information may be obtained by averaging the implicit vectors belonging to the same description information. Similarly, the vector representation corresponding to each of the plurality of pieces of description information may be obtained.

At step 302, a sentence-level feature value vector of each of the plurality of pieces of description information is acquired by inputting the vector representation of each of the plurality of pieces of description information into the RNN sentence-level encoder for encoding processing and compressing.

In some embodiments of the disclosure, the vector representation corresponding to each of the plurality of pieces of description information may be input into the RNN sentence-level encoder, and the RNN sentence-level encoder may obtain a value vector of a fixed dimension by compressing the vector representation. The value vector is the sentence-level feature value vector. It may be understood that each of the plurality of pieces of description information may correspond to one sentence-level feature value vector.

A structure of the RNN sentence-level encoder may be designed according to a same application scenario, which is not limited in the embodiments. For example, the RNN sentence-level encoder may be a unit including one or more recurrent neurons.

At step 303, the degree of correlation between each of the plurality of pieces of description information and the element type is acquired by a classification matrix by inputting the sentence-level feature value vector and the element embedding feature into the classifier.

In some embodiments of the disclosure, there may be a classifier, and inputs of the classifier are the sentence-level feature value vector and the element embedding feature. There may further be the classification matrix in the classification model, and the element embedding feature may be combined with each sentence-level feature value vector respectively, and pass through the same classification matrix. The elements of the classification matrix may be some preset parameters.

The output of the classification matrix may pass a sigmoid function to obtain the degree of correlation. The value range of the degree of correlation is 0-1. The degree of correlation represents the degree of correlation between each of the plurality of pieces of description information and the current element type. The more the description information is related to the element type, and the closer the degree of correlation is to 1, otherwise, the closer the degree of correlation is to 0.

In some embodiments of the disclosure, calculation of a classification loss may also be performed based on the above embodiments. The above embodiments may further include steps 1 to 3:

At step 1, a word overlap rate between each of the plurality of pieces of description information and the sample abstract is calculated.

In some embodiments of the disclosure, a number of words that each of the plurality of pieces of description information overlaps with the sample abstract may be calculated, and the number of overlapped words is divided by a total number of words in the description information, to obtain the word overlap rate between the description information and the sample abstract.

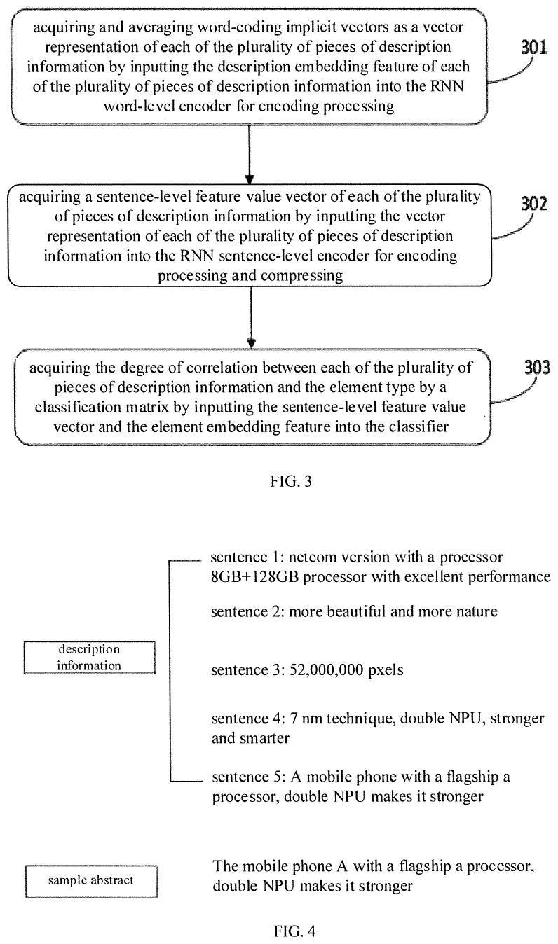

FIG. 4 is a diagram illustrating comparison of word overlap rates according to embodiments of the disclosure.

The sample object is a mobile phone A, and the sample abstract and the plurality of pieces of description information are as illustrated in FIG. 4. It can be seen from FIG. 4 that the element type of the sample abstract is performance; and the element types of the plurality of pieces of description information include photographing and performance. A word overlap rate is calculated, and overlap rates of a sentence 1 to a sentence 5 are 0.4, 0, 0, 0.4, 0.125, in sequence.

At step 2, a label matrix representing a degree of correlation between description information and abstract is generated by comparing the word overlap rate with a preset overlap rate threshold.

In some embodiments of the disclosure, the overlap rate threshold may be preset. The threshold may be compared with the word overlap rate, the description information greater than or equal to the overlap rate threshold may be given a classification label “1”, and the description information less than the threshold may be given a classification label “0”. The classification label represents the degree of correlation between the description information and the abstract, and may be configured for the classification matrix in step 303, and the classification labels may be referred to as the label matrix.

As illustrated in FIG. 4, when the overlap rate threshold is 0.35, the sentence 1 to the sentence 5 are given classification labels: 1, 0, 0, 1, 0, respectively.

At step 3, the classification loss value of the first model is generated based on the label matrix.

It may be understood that the classification loss value of the first model may be generated based on the label matrix, and model learning is performed by gradient back propagation.

Through steps 1 to 3, the degree of correlation between the description information and the abstract may be accurately and quickly acquired, to generate the label matrix. The degree of correlation generated by the first model may be more accurate through the classification loss value of the first model generated by the label matrix.

At step 304, a merged embedding feature is acquired by adding the element embedding feature and the description embedding feature, the merged embedding feature is input into the RNN encoder for processing to acquire a processing result, and the processing result is input into the RNN decoder. The degree of correlation between each of the plurality of pieces of description information and the element type, output from the first model, is used as an input of the RNN decoder.

In some embodiments of the disclosure, the merged embedding feature may be acquired by adding the element embedding feature and the description embedding feature, and the merged embedding feature may be input into the RNN encoder for processing, and the RNN encoder may obtain an embedding feature corresponding to the description information after encoding.

The processing result of the RNN encoder is input into the RNN decoder, and the RNN decoder inputs three parameters at each decoding moment, which are a hidden state at a previous moment, a corresponding embedding vector decoded and output, and a context vector, respectively. The RNN decoder may generate a hidden state feature at a current moment at each decoding moment, and the hidden state feature at the current moment may calculate a word-level attention weight with each output of the RNN encoder.

The input of the RNN decoder further includes the degree of correlation between each of the plurality of pieces of description information and the element type, output by the first model. The degree of correlation may be used as a sentence-level weight corresponding to the description information, to multiply and re-normalize the word-level attention weight of each word corresponding to the description information, that is, the sentence-level attention may be allocated to the corresponding word-level attention to generate an updated word-level attention. Therefore, a weight of a word in a sentence with a higher degree of association with the element type is increased; and a weight of a word in a sentence with a lower degree of association with the element type is reduced.

A weighted summation may be performed on the updated word-level attention and the encoded output of the RNN encoder to obtain a context vector of a fixed dimension, and the context vector of the fixed dimension is used as one of inputs of the RNN decoder, so that the RNN decoder generates the commodity abstract output that is only consistent with the current element type.

A structure of the RNN encoder and the RNN decoder may be designed according to the same application scenario, which are not limited in the embodiment. For example, the RNN encoder and the RNN decoder may include one or more recurrent neurons.

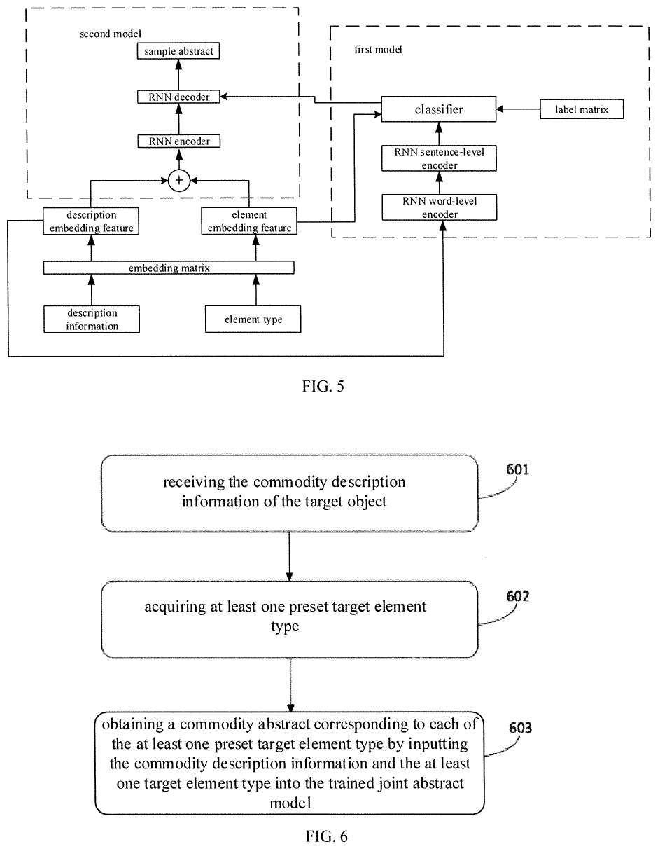

In some embodiments of the disclosure, a structure of the joint abstract model may be as illustrated in FIG. 5. FIG. 5 is a diagram illustrating a structure of a joint abstract model according to embodiments of the disclosure.

In embodiments of the disclosure, the description information is processed by the embedding matrix to obtain the corresponding description embedding feature, and the element information is processed by the embedding matrix to obtain the corresponding element embedding feature. The joint abstract model includes the first model and the second model.

In the first model, the description embedding feature is processed by the RNN word-level encoder to obtain an implicit vector encoded by each word, and implicit vectors corresponding to words in each description information are averaged to obtain the vector representation of each of the plurality of pieces of description information. The sentence-level feature value vector of each of the plurality of pieces of description information is acquired by inputting the vector representation into the RNN sentence-level encoder for encoding processing and compressing. The degree of correlation between each of the plurality of pieces of description information and the element type is acquired by inputting the sentence-level feature value vector, the element embedding feature and the label matrix into the classifier.

In the second model, the merged embedding feature is acquired by adding the element embedding feature and the description embedding feature and the merged embedding feature is input into the RNN encoder for processing. The sample abstract is obtained by inputting the processing result and the degree of correlation obtained by the first model into the RNN decoder.

According to the method for processing an element text in embodiments of the disclosure, in the first model, a semantic representation of each word is further enriched by the RNN word-level encoder on the basis of the description embedding feature. Information interaction and feature modeling between words and between sentences are enhanced by the RNN sentence-level encoder, so that the model learns a rich feature representation.

In the second model, a degree of correlation between the word in each of the plurality of pieces of description information and the element feature is enhanced by adding the element embedding feature and the description embedding feature. By inputting the degree of correlation generated by the first model, a weight of a word in a sentence with a higher degree of association with the element type is increased; and a weight of a word in a sentence with a lower degree of association with the element type is reduced. At the same time, controllability of the model is increased.

In embodiments of the disclosure, description information of a commodity may be processed by using the joint abstract model, thereby obtaining a corresponding commodity abstract. In some embodiments, the implementation of generating the commodity abstract matching the target element type by processing the commodity description information of the target object may include steps 601 to 603.

FIG. 6 is a flowchart illustrating a method for processing an element text according to embodiments of the disclosure.

At step 601, the commodity description information of the target object is received.

It may be understood that, after the joint abstract model are trained, according to the method for processing an element text in embodiments of the disclosure, the corresponding commodity abstract may be output for the input commodity description information and the target element type.

In some embodiments of the disclosure, the target object includes, but is not limited to a mobile phone, a computer and other commodity. The commodity has detailed description information, and a description of a plurality of element types may be generally included in the commodity description information.

At step 602, at least one preset target element type is acquired.

In some embodiments of the disclosure, a target element type may be preset, and the target element type is an element type corresponding to the commodity abstract.

At step 603, a commodity abstract corresponding to each of the target element types is obtained by inputting the commodity description information and the at least one target element type into the trained joint abstract model.

In some embodiments of the disclosure, the commodity description information and the at least one target element type may be used as inputs and may be input into the trained joint abstract model, and the joint abstract model may output the commodity abstract corresponding to each target element type.

According to the method for processing an element text in embodiments of the disclosure, the readable commodity abstract related to the target element type may be rapidly and efficiently generated based on the acquired commodity description information and the target element type of the target object.

According to embodiments of the disclosure, an apparatus for processing an element text is further provided.

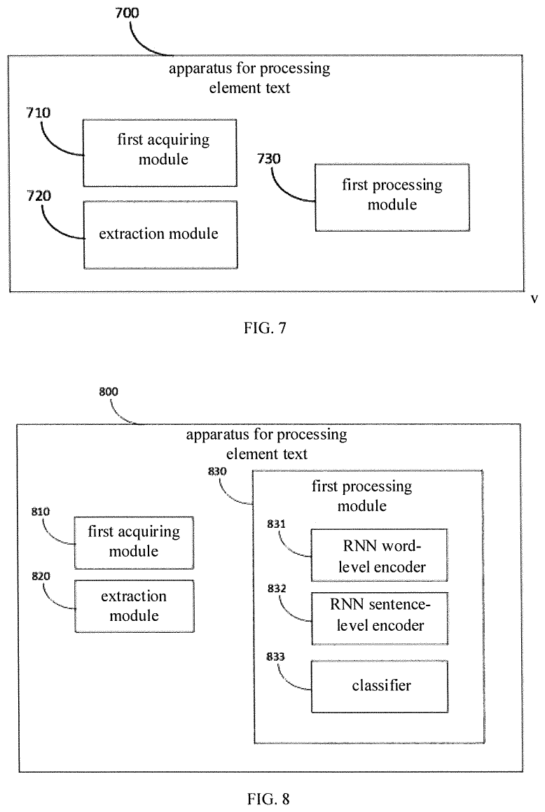

FIG. 7 is a block diagram illustrating an apparatus for processing an element text according to embodiments of the disclosure. As illustrated in FIG. 7, the apparatus 700 for processing an element text may include a first acquiring module 710, an extraction module 720 and a first processing module 730.

The first acquiring module 710 is configured to acquire a plurality of pieces of description information and a sample abstract labeled with an element type, of a sample object.

The extraction module 720 is configured to extract an element embedding feature of the element type and a description embedding feature of each of the plurality of pieces of description information.

The first processing module 730 is configured to use the element embedding feature and the description embedding feature as inputs of a joint abstract model to be trained, and use the sample abstract as an output of the joint abstract model, in which the joint abstract model includes a first model and a second model, and a degree of correlation between each of the plurality of pieces of description information and the element type, output from the first model, is used as an input of the second model, and train the joint abstract model based on a classification loss value of the first model and a decoding loss value of the second model, to process commodity description information of a target object to generate a commodity abstract matching a target element type.

In some embodiments of the disclosure, as illustrated in FIG. 8, FIG. 8 is a block diagram illustrating an apparatus for processing an element text according to embodiments of the disclosure.

In the apparatus 800 for processing an element text, a first processing module 830 includes a recurrent neural network (RNN) word-level encoder 831, an RNN sentence-level encoder 832 and a classifier 833.

Word-coding implicit vectors are acquired and averaged as a vector representation of each of the plurality of pieces of description information by inputting the description embedding feature of each of the plurality of pieces of description information into the RNN word-level encoder for encoding processing.

A sentence-level feature value vector of each of the plurality of pieces of description information is acquired by inputting the vector representation of each of the plurality of pieces of description information into the RNN sentence-level encoder for encoding processing and compressing.

The degree of correlation between each of the plurality of pieces of description information and the element type is acquired by a classification matrix by inputting the sentence-level feature value vector and the element embedding feature into the classifier.

810 and 820 in FIG. 8 have the same function and structure with 710 and 720 in FIG. 7.

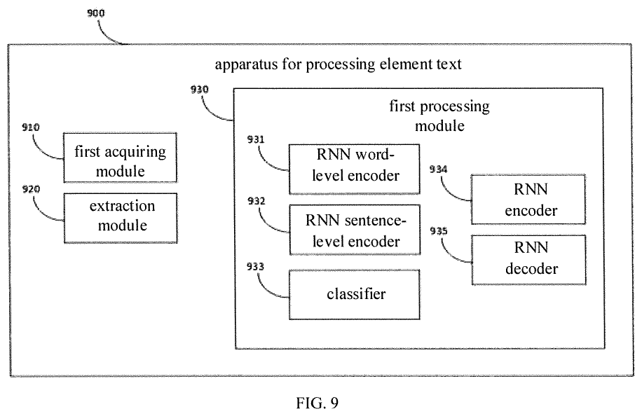

In some embodiments of the disclosure, as illustrated in FIG. 9, FIG. 9 is a block diagram illustrating a structure of an apparatus for processing an element text according to embodiments of the disclosure. In the apparatus 900 for processing an element text, a first processing module 930 further includes an RNN encoder 934 and an RNN decoder 935.

A merged embedding feature is acquired by adding the element embedding feature and the description embedding feature, the merged embedding feature is input into RNN encoder for processing to acquire a processing result, and the processing result is input into the RNN decoder. The degree of correlation between each of the plurality pieces of description information and the element type output by the classifier is an input of the RNN decoder.

910 and 920 in FIG. 9 have the same functions and structures as 810 and 820 in FIG. 8, and 931 to 933 in FIG. 9 have the same functions and structures as 831 to 833 in FIG. 8.

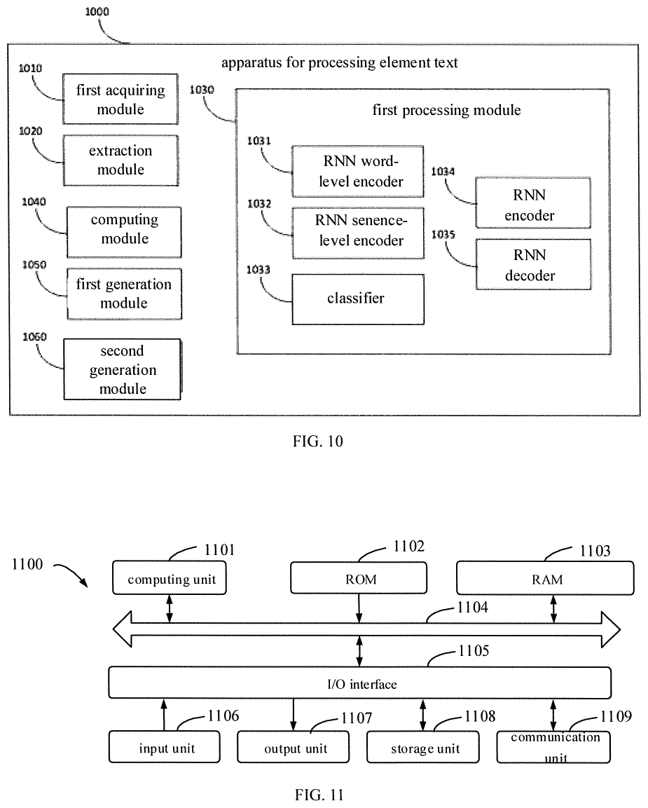

In some embodiments of the disclosure, as illustrated in FIG. 10, FIG. 10 is a block diagram illustrating a structure of an apparatus for processing an element text according to embodiments of the disclosure. The apparatus 1000 for processing an element text further includes a calculation module 1040, a first generation module 1050 and a second generation module 1060.

The calculation module 1040 is configured to calculate a word overlap rate between each of the plurality of pieces of description information and the sample abstract.

The first generation module 1050 is configured to generate a label matrix representing a degree of correlation between description information and abstract by comparing the word overlap rate with a preset overlap rate threshold.

The second generation module 1060 is configured to generate the classification loss value of the first model based on the label matrix.

1010 to 1030 in FIG. 10 have the same function and structure with 910 to 930 in FIG. 9.

In some embodiments of the disclosure, an implementation process during which the first processing module 730 processes the commodity description information of the target object to generate a commodity abstract matching a target element type is as follow: the commodity description information of the target object is received; at least one preset target element type is acquired; and a commodity abstract corresponding to each of the at least one preset target element type is obtained by inputting the commodity description information and the at least one target element type into the trained joint abstract model.

With regards to the apparatus in the above embodiments, the specific way in which each module performs the operation has been described in detail in the embodiments of the method and will not be elaborated herein.

In embodiments of the disclosure, an electronic device, a readable storage medium and a computer program product are further provided according to embodiments of the disclosure.

FIG. 11 is an example block diagram illustrating an example electronic device 1100 in the embodiment of the disclosure. The electronic device is intended to represent various types of digital computers, such as laptop computers, desktop computers, workstations, personal digital assistants, servers, blade servers, mainframe computers, and other suitable computers. The electronic device may also represent various types of mobile apparatuses, such as personal digital assistants, cellular phones, smart phones, wearable devices, and other similar computing devices. The components shown herein, their connections and relations, and their functions are merely examples, and are not intended to limit the implementation of the disclosure described and/or required herein.

As illustrated in FIG. 11, the device 1100 includes a computing unit 1101, configured to execute various appropriate actions and processes according to a computer program stored in a read-only memory (ROM) 1102 or loaded from a storage unit 1108 to a random access memory (RAM) 1103. In the RAM 1103, various programs and data required for the device 1100 may be stored. The computing unit 1101, the ROM 1102 and the RAM 1103 may be connected with each other by a bus 1104. An input/output (I/O) interface 1105 is also connected to the bus 1104.

A plurality of components in the device 1100 are connected to an I/O interface 1105, and include: an input unit 1106, for example, a keyboard, a mouse; an output unit 1107, for example, various types of displays, speakers; a storage unit 1108, for example, a magnetic disk, an optical disk; and a communication unit 1109, for example, a network card, a modem, a wireless transceiver. The communication unit 1109 allows the device 1100 to exchange information/data through a computer network such as internet and/or various types of telecommunication networks and other devices.

The computing unit 1101 may be various types of general and/or dedicated processing components with processing and computing ability. Some examples of the computing unit 1101 include but not limited to a central processing unit (CPU), a graphics processing unit (GPU), various dedicated artificial intelligence (AI) computing chips, various computing units running a machine learning model algorithm, a digital signal processor (DSP), and any appropriate processor, controller, microcontroller, etc. The computing unit 1101 executes various methods and processings as described above, for example, a method for processing an element text. For example, in some embodiments, the method for processing an element text may be further implemented as a computer software program, which is physically contained in a machine readable medium, such as the storage unit 1108. In some embodiments, a part or all of the computer program may be loaded and/or installed on the device 1100 through the ROM 1102 and/or the communication unit 1109. When the computer program is loaded on a RAM 1103 and executed by a computing unit 1101, one or more blocks in the method for processing an element text as described above may be performed. Alternatively, in other embodiments, a computing unit 1101 may be configured to execute a method for processing an element text in other appropriate ways (for example, by virtue of a firmware).

Various implementation modes of systems and technologies described herein may be implemented in a digital electronic circuit system, an integrated circuit system, a field programmable gate array (FPGA), a dedicated application specific integrated circuit (ASIC), a system on a chip (SoC), a load programmable logic device (CPLD), a computer hardware, a firmware, a software, and/or combinations thereof. The various implementation modes may include: being implemented in one or more computer programs, and the one or more computer programs may be executed and/or interpreted on a programmable system including at least one programmable processor, and the programmable processor may be a dedicated or a general-purpose programmable processor that may receive data and instructions from a storage system, at least one input apparatus, and at least one output apparatus, and transmit the data and instructions to the storage system, the at least one input apparatus, and the at least one output apparatus.

A computer code configured to execute a method in the disclosure may be written with one or any combination of multiple programming languages. These programming languages may be provided to a processor or a controller of a general purpose computer, a dedicated computer, or other apparatuses for programmable data processing so that the function/operation specified in the flowchart and/or block diagram may be performed when the program code is executed by the processor or controller. A computer code may be executed completely or partly on the machine, executed partly on the machine as an independent software package and executed partly or completely on the remote machine or server.

In the context of the disclosure, a machine-readable medium may be a tangible medium that may contain or store a program intended for use in or in conjunction with an instruction execution system, apparatus, or device. A machine-readable medium may be a machine readable signal medium or a machine readable storage medium. The machine-readable storage medium may include but not limited to an electronic, magnetic, optical, electromagnetic, infrared, or semiconductor system, apparatus or device, or any appropriate combination thereof. A more specific example of a machine readable storage medium includes an electronic connector with one or more cables, a portable computer disk, a hardware, a random access memory (RAM), a read-only memory (ROM), an EPROM programmable read-only ROM (an EPROM or a flash memory), an optical fiber device, and a portable optical disk read-only memory (CDROM), an optical storage device, a magnetic storage device, or any appropriate combination of the above.

In order to provide interaction with the user, the systems and technologies described here may be implemented on a computer, and the computer has: a display apparatus for displaying information to the user (for example, a CRT (cathode ray tube) or a LCD (liquid crystal display) monitor); and a keyboard and a pointing apparatus (for example, a mouse or a trackball) through which the user may provide input to the computer. Other types of apparatuses may further be configured to provide interaction with the user; for example, the feedback provided to the user may be any form of sensory feedback (for example, visual feedback, auditory feedback, or tactile feedback); and input from the user may be received in any form (including an acoustic input, a speech input, or a tactile input).

The systems and technologies described herein may be implemented in a computing system including back-end components (for example, as a data server), or a computing system including middleware components (for example, an application server), or a computing system including front-end components (for example, a user computer with a graphical user interface or a web browser through which the user may interact with the implementation mode of the system and technology described herein), or a computing system including any combination of such back-end components, middleware components or front-end components. The system components may be connected to each other through any form or medium of digital data communication (for example, a communication network). Examples of communication networks include: a local area network (LAN), a wide area network (WAN), an internet and a blockchain network.

The computer system may include a client and a server. The client and server are generally far away from each other and generally interact with each other through a communication network. The relation between the client and the server is generated by computer programs that run on the corresponding computer and have a client-server relationship with each other. A server may be a cloud server, also known as a cloud computing server or a cloud host, is a host product in a cloud computing service system, to solve the shortcomings of large management difficulty and weak business expansibility existed in the traditional physical host and Virtual Private Server (VPS) service. A server further may be a server with a distributed system, or a server in combination with a blockchain.

According to the method for processing an element text in embodiments of the disclosure, the element type and the element embedding feature corresponding to the element type are acquired, and the description information and the description embedding feature corresponding to the description information are acquired. The above two embedding features are used as inputs of the joint abstract model, and the sample abstract is used as the output of the joint abstract model to train the joint abstract model. The trained joint abstract model may generate the text abstract by processing the description information.

The method is highly controllable. Different levels of target element types may be set based on different application scenarios, and different text abstracts are generated by controlling the model based on different target element types, and the generated text abstract matches the target element type. Moreover, since the method is based on a generative abstract technology and is not based on an extraction abstract technology, the generated text abstract is readable and conforms to a language habit of human beings.

The more accurate and credible feature embedding is obtained by using the vocabulary mapping table and the embedding matrix, so that calculation of the degree of correlation between the description information and the element type is more accurate. The finally generated text abstract is more closely related to the target element type and the controllability is stronger.

In the first model, a semantic representation of each word is further enriched by an RNN word-level encoding layer on the basis of the description embedding feature. Information interaction and feature modeling between words and between sentences are enhanced by an RNN sentence-level encoding layer, so that the model learns a rich feature representation.

In the second model, a degree of correlation between the word in each of the plurality of pieces of description information and the element feature is enhanced by adding the element embedding feature and the description embedding feature. By inputting the degree of correlation generated by the first model, a weight of a word in a sentence with a higher degree of association with the element type is increased; and a weight of a word in a sentence with a lower degree of association with the element type is reduced. At the same time, controllability of the model is increased.

According to the method for processing an element text in embodiments of the disclosure, the readable commodity abstract related to the target element type may be rapidly and efficiently generated based on the acquired commodity description information and the target element type of the target object.

It should be understood that, various forms of procedures shown above may be configured to reorder, add or delete blocks. For example, blocks described in the disclosure may be executed in parallel, sequentially, or in a different order, as long as the desired result of the technical solution disclosed in the disclosure may be achieved, which will not be limited herein.

The above specific implementations do not constitute a limitation on the protection scope of the disclosure. Those skilled in the art should understand that various modifications, combinations, sub-combinations and substitutions may be made according to design requirements and other factors.

Any modification, equivalent replacement, improvement, etc., made within the spirit and principle of embodiments of the disclosure shall be included within the protection scope of embodiments of the disclosure.

1. A method for processing an element text, comprising:
acquiring a plurality of pieces of description information and a sample abstract labeled with an element type, of a sample object;
extracting an element embedding feature of the element type and a description embedding feature of each of the plurality of pieces of description information; and
using the element embedding feature and the description embedding feature as inputs of a joint abstract model to be trained, and using the sample abstract as an output of the joint abstract model, wherein the joint abstract model comprises a first model and a second model, and a degree of correlation between each of the plurality of pieces of description information and the element type, output from the first model, is used as an input of the second model; and
training the joint abstract model based on a classification loss value of the first model and a decoding loss value of the second model, to process commodity description information of a target object to generate a commodity abstract matching a target element type.

2. The method according to claim 1, wherein, the sample abstract labeled with the element type comprises:
clustering a plurality of sample abstracts, and labeling sets of sample abstracts belonging to different element types.

3. The method according to claim 1, wherein, extracting the element embedding feature of the element type and the description embedding feature of each of the plurality of pieces of description information, comprises:
acquiring a corresponding element type digital number and a corresponding description information digital number by converting the element type and a character string of each of the plurality of pieces of description information based on a preset vocabulary mapping table; and
generating the element embedding feature and the description embedding feature of each of the plurality of pieces of description information by processing the element type digital number and the description information digital number based on a preset embedding matrix.

4. The method according to claim 1, wherein, the first model comprises a recurrent neural network (RNN) word-level encoder, an RNN sentence-level encoder and a classifier, wherein,
word-coding implicit vectors are acquired and averaged as a vector representation of each of the plurality of pieces of description information by inputting the description embedding feature of each of the plurality of pieces of description information into the RNN word-level encoder for encoding processing;
a sentence-level feature value vector of each of the plurality of pieces of description information is acquired by inputting the vector representation of each of the plurality of pieces of description information into the RNN sentence-level encoder for encoding processing and compressing; and
the degree of correlation between each of the plurality of pieces of description information and the element type is acquired by a classification matrix by inputting the sentence-level feature value vector and the element embedding feature into the classifier.

5. The method according to claim 4, wherein, the second model comprises an RNN encoder and an RNN decoder, wherein,
a merged embedding feature is acquired by adding the element embedding feature and the description embedding feature, the merged embedding feature is input into the RNN encoder for processing to acquire a processing result, and the processing result is input into the RNN decoder, wherein the degree of correlation between each of the plurality of pieces of description information and the element type output by the first model is an input of the RNN decoder.

6. The method according to claim 1, further comprising:
calculating a word overlap rate between each of the plurality of pieces of description information and the sample abstract;
generating a label matrix representing a degree of correlation between description information and abstract by comparing the word overlap rate with a preset overlap rate threshold; and
generating the classification loss value of the first model based on the label matrix.

7. The method according to claim 1, further comprising:
receiving the commodity description information of the target object;
acquiring at least one preset target element type; and
obtaining a commodity abstract corresponding to each of the at least one preset target element type by inputting the commodity description information and the at least one target element type into the trained joint abstract model.

8.-14. (canceled)

15. An electronic device, comprising:
a processor; and
a memory communicatively connected to the processor and stored with instructions executable by the processor,
wherein the processor is e configured to perform the following actions:
acquiring a plurality of pieces of description information and a sample abstract labeled with an element type, of a sample object;
extracting an element embedding feature of the element type and a description embedding feature of each of the plurality of pieces of description information;
using the element embedding feature and the description embedding feature as inputs of a joint abstract model to be trained, and using the sample abstract as an output of the joint abstract model, wherein the joint abstract model comprises a first model and a second model, and a degree of correlation between each of the plurality of pieces of description information and the element type, output from the first model, is used as an input of the second model; and
training the joint abstract model based on a classification loss value of the first model and a decoding loss value of the second model, to process commodity description information of a target object to generate a commodity abstract matching a target element type.

16. A non-transitory computer-readable storage medium having computer instructions stored thereon, wherein the computer instructions are configured to cause a computer to perform a method for processing an element text, the method comprising:
acquiring a plurality of pieces of description information and a sample abstract labeled with an element type, of a sample object;
extracting an element embedding feature of the element type and a description embedding feature of each of the plurality of pieces of description information;
using the element embedding feature and the description embedding feature as inputs of a joint abstract model to be trained, and using the sample abstract as an output of the joint abstract model, wherein the joint abstract model comprises a first model and a second model, and a degree of correlation between each of the plurality of pieces of description information and the element type, output from the first model, is used as an input of the second model; and
training the joint abstract model based on a classification loss value of the first model and a decoding loss value of the second model, to process commodity description information of a target object to generate a commodity abstract matching a target element type.

17. (canceled)

18. The device according to claim 15, wherein the processor is configured to perform the following actions:
clustering a plurality of sample abstracts, and labeling sets of sample abstracts belonging to different element types.

19. The device according to claim 15, wherein the processor is configured to perform the following actions:
acquiring a corresponding element type digital number and a corresponding description information digital number by converting the element type and a character string of each of the plurality of pieces of description information based on a preset vocabulary mapping table; and
generating the element embedding feature and the description embedding feature of each of the plurality of pieces of description information by processing the element type digital number and the description information digital number based on a preset embedding matrix.

20. The device according to claim 15, wherein, the first model comprises a recurrent neural network (RNN) word-level encoder, an RNN sentence-level encoder and a classifier, wherein,
word-coding implicit vectors are acquired and averaged as a vector representation of each of the plurality of pieces of description information by inputting the description embedding feature of each of the plurality of pieces of description information into the RNN word-level encoder for encoding processing;
a sentence-level feature value vector of each of the plurality of pieces of description information is acquired by inputting the vector representation of each of the plurality of pieces of description information into the RNN sentence-level encoder for encoding processing and compressing; and
the degree of correlation between each of the plurality of pieces of description information and the element type is acquired by a classification matrix by inputting the sentence-level feature value vector and the element embedding feature into the classifier.

21. The device according to claim 20, wherein, the second model comprises an RNN encoder and an RNN decoder, wherein,
a merged embedding feature is acquired by adding the element embedding feature and the description embedding feature, the merged embedding feature is input into the RNN encoder for processing to acquire a processing result, and the processing result is input into the RNN decoder, wherein the degree of correlation between each of the plurality of pieces of description information and the element type output by the first model is an input of the RNN decoder.

22. The device according to claim 15, wherein the processor is configured to perform the following actions:
calculating a word overlap rate between each of the plurality of pieces of description information and the sample abstract;
generating a label matrix representing a degree of correlation between description information and abstract by comparing the word overlap rate with a preset overlap rate threshold; and
generating the classification loss value of the first model based on the label matrix.

23. The device according to claim 15, wherein the processor is configured to perform the following actions:
receiving the commodity description information of the target object;
acquiring at least one preset target element type; and
obtaining a commodity abstract corresponding to each of the at least one preset target element type by inputting the commodity description information and the at least one target element type into the trained joint abstract model.

24. The non-transitory computer-readable storage medium according to claim 16, wherein, the sample abstract labeled with the element type comprises:
clustering a plurality of sample abstracts, and labeling sets of sample abstracts belonging to different element types.

25. The non-transitory computer-readable storage medium according to claim 16, wherein, extracting the element embedding feature of the element type and the description embedding feature of each of the plurality of pieces of description information, comprises:
acquiring a corresponding element type digital number and a corresponding description information digital number by converting the element type and a character string of each of the plurality of pieces of description information based on a preset vocabulary mapping table; and
generating the element embedding feature and the description embedding feature of each of the plurality of pieces of description information by processing the element type digital number and the description information digital number based on a preset embedding matrix.

26. The non-transitory computer-readable storage medium according to claim 16, wherein, the first model comprises a recurrent neural network (RNN) word-level encoder, an RNN sentence-level encoder and a classifier, wherein,
word-coding implicit vectors are acquired and averaged as a vector representation of each of the plurality of pieces of description information by inputting the description embedding feature of each of the plurality of pieces of description information into the RNN word-level encoder for encoding processing;
a sentence-level feature value vector of each of the plurality of pieces of description information is acquired by inputting the vector representation of each of the plurality of pieces of description information into the RNN sentence-level encoder for encoding processing and compressing; and
the degree of correlation between each of the plurality of pieces of description information and the element type is acquired by a classification matrix by inputting the sentence-level feature value vector and the element embedding feature into the classifier.

27. The non-transitory computer-readable storage medium according to claim 26, wherein, the second model comprises an RNN encoder and an RNN decoder, wherein,
a merged embedding feature is acquired by adding the element embedding feature and the description embedding feature, the merged embedding feature is input into the RNN encoder for processing to acquire a processing result, and the processing result is input into the RNN decoder, wherein the degree of correlation between each of the plurality of pieces of description information and the element type output by the first model is an input of the RNN decoder.

28. The non-transitory computer-readable storage medium according to claim 16, wherein the method further comprises:
calculating a word overlap rate between each of the plurality of pieces of description information and the sample abstract;
generating a label matrix representing a degree of correlation between description information and abstract by comparing the word overlap rate with a preset overlap rate threshold; and
generating the classification loss value of the first model based on the label matrix.
